(19) United States
(12) Patent Application Publication
(10) Pub. No.: US 2021/0331907 A1
(43) Pub. Date: Oct. 28, 2021

(54) Filling and Packaging of Crafted Cocktails and Drinks and Method

(71) Applicant: Andrew Belen, Loma Linda, CA (US)

(72) Inventor: Andrew Belen, Loma Linda, CA (US)

(21) Appl. No.: 17/202,051

(22) Filed: Mar. 15, 2021

Related U.S. Application Data
(60) Provisional application No. 63/016,752, filed on Apr. 28, 2020.

(51) Int. Cl. B67C 3/02; B67C 3/26; B67C 3/22; B67C 7/00

(52) U.S. Cl. CPC B67C 3/026; B67C 3/26; B67C 2003/226; B67C 7/0006; B67C 3/225

(57) ABSTRACT

A system that dispenses precise amounts of ingredients in sequential steps that formulate a craft cocktail, mixed drink or shot into a single serve beverage container. The system then closes the container and a resulting vacuum is created that hermetically seals the lid to the container. The sealed container is then agitated in a prescribed motion to mix the contents as they would normally be done by expert individuals in the field of mixology or bartending. The system comprises of a series of stations that inject ingredients, a closing mechanism for the lid resulting in a vacuum that seals the lid to the container body, method of maintaining the lid on to the container body until vacuum is established, and agitating mechanism that precisely mixes the ingredients into themselves prior to finish packing.

### CROSS-REFERENCE TO RELATED APPLICATIONS

This application claims priority from U.S. Provisional Patent Application No. 63/016,752 filed on Apr. 28, 2020. The entire disclosure of the prior application is considered to be part of the disclosure of the accompanying application and is hereby incorporated by reference.

### BACKGROUND

Craft cocktails, mixed drinks and shots have typically been limited to consumption at a bar, club or other establishment selling alcohol serviced by a bartender or similarly skilled personnel. A number of services offer mixed drinks and cocktails as a subscription by which the ingredients are separately supplied and the consumer is tasked with completing the drink by combining the ingredients per accompanying instructions. In yet another variant, a multi-portion serving size is supplied pre-made, in bulk, by a mixologist, and whatever the drink that is prepared at that time, that is what the consumer will get. Conversely, mass-produced options lack the quality, limitation on ingredients and precision that is demanded of a craft cocktail. These alternatives limit the convenience, options and product quality that the consumer desires in a craft drink that could be consumed at his or her pleasure. Together with a unique container design the invention herein describes a way to produce craft cocktails in large quantities while maintaining the quality expected in the final product, accuracy in filling ingredients in order of real recipes and expertly finishes the mixing of the drink such that it is intended when served by a skilled bartender or mixologist. Furthermore, the invention also provides for a robust closing and sealing system so that the package is hermetically sealed; no oxygen ingress or egress, ensuring quality during distribution and a long shelf-life for product consumption.

### SUMMARY

One embodiment of the invention relates to a system that is single or multiple lane system in which a series of nozzles are placed overhead of a single or plurality of containers. The containers are advanced accurately under a series of nozzles that then dispense a prescribed ingredient precisely into the container. The container is then moved to the next filling station where a second ingredient is dispensed and onward the container advances until all ingredients are put in. The number of filling stations can vary dependent on the quantity of ingredients to be filled.

Another embodiment of the invention relates to a single or multiple lane system in which the filling process is consolidated into a single station whereby all the nozzles by which ingredients are dispensed are located in one overhead position and dispense the ingredients at that point, simultaneously or alternating or a combination of both depending on the recipe of the drink being produced.

Another embodiment of the invention relates to a single or multiple lane system in which a single or plurality of nozzles placed in a plurality filling stations where the ingredients are dispensed simultaneously or alternating or a combination of both depending on the recipe of the drink being produced.

Another embodiment of the invention relates to method for closing the container using a lid which then results in a vacuum in the interior of the sealed container. The filled container has a headspace representing 5 to 10% of the container volume, but no more than 10%; is introduced into a saturated steam environment whereby the steam displaces the ambient oxygen/air mixture in the headspace. Once displacement occurs, the lid is applied on to the container body, and a constant force applied to the lid to maintain placement until a vacuum is achieved.

One embodiment identifies the force applied to lid as a mechanical force using a solid fixture or cover which is placed on a single container or plurality of containers.

Another embodiment identifies the force applied to the lid as a pneumatic force which applies pressure to a single container or plurality of containers.

Another embodiment utilizes a vacuum chamber whereby filled containers have lids applied in a vacuum condition such that the resulting vacuum is created when the sealed container is reintroduced to ambient conditions.

Another embodiment of the invention relates to the immediate cooling of the sealed container when the saturated steam method described in [0005] is used. Water at a prescribed temperature is applied to the sealed container at a defined flow rate and duration. The water cools the saturated steam trapped in the container causing it to cool and creating a vacuum necessary to keep the lid in place; creating a hermetic seal.

One embodiment identifies the water application method to be a spray system whereby the water is driven through the air in drops; randomly falling on the sealed containers.

Another embodiment identifies the water application method to be a constant waterfall that causes the water to fall at a constant rate over the tops of the sealed containers.

Another embodiment of the invention relates to the design of the solid fixture or cover plate that is placed over the sealed containers just after filling and during the cooling process. The cover plate is comprised of a durable material such as stainless steel as its base combined with a material that mitigates any scratching or abrasion as it makes contact with the container lid.

Another embodiment of the invention relates to the design of the solid fixture or cover plate that is placed over the sealed containers just after filling and during the cooling process. Whereby a plurality of holes, cavities, voids are purposely incorporated into the plate allowing for a prescribed amount of water to flow through while simultaneously providing enough force to keep the lids in place until a vacuum is established within the containers.

Another embodiment of the invention relates to the agitation method applied to the sealed containers whereby the assembly containing a plurality of containers is moved in vertical motion with a defined displacement and frequency; creating a “shake” finish.

Another embodiment of the invention relates to the agitation method applied to the sealed containers whereby the assembly containing a plurality of the containers is moved in a horizontal motion in a prescribed displacement and frequency about the vertical axis of the containers; creating a “stirred” finish.

Another embodiment of the invention relates to the design of the baseplate which holds the sealed containers in place during the cooling and agitating process. The baseplate design incorporates machined pockets at a depth and match the bottom diameter of the containers such that the container is firmly retained and mitigates any movement during the cooling and agitation process.

Another embodiment of the invention relates to the design of the baseplate and machine pockets where the distance between the machine pockets is critical and defined such that there is no interference between a plurality of processed containers.

### BRIEF DESCRIPTION OF THE DRAWINGS

FIG. 1 is a perspective view of the container and nozzle arrangement

FIG. 2 is a side view of the container and nozzle arrangement;

FIG. 3 is a perspective view of the container and nozzle arrangement with multiple lanes and combinations;

FIG. 4 is a perspective view of the saturated steam insertion arrangement;

FIG. 5 is a side view of the saturated steam insertion arrangement;

FIG. 6 is a perspective view of the lid application process in a vacuum unit;

FIG. 7 is perspective view of the top cover plate assembly;

FIG. 8 is a top view of the top cover plate assembly;

FIG. 9 is a side view of the top cover plate assembly;

FIG. 10 is a detailed view of the top cover plate assembly;

FIG. 11 is a perspective view of the spray cooling system;

FIG. 12 is a side view of the spray cooling system;

FIG. 13 is a perspective view of the waterfall cooling system;

FIG. 14 is a side view of the waterfall cooling system;

FIG. 15 is a top view of the baseplate assembly;

FIG. 16 is a side view of the baseplate assembly; assembly;

FIG. 17 is a perspective view of the baseplate

FIG. 18 is a detailed view of the pockets of the baseplate assembly;

FIG. 19 is a perspective view of the top cover plate and baseplate assembly containing a plurality of filled containers;

FIG. 20 is a detailed view of the cover plate and baseplate assembly containing a plurality of filled containers;

FIG. 21 is a side view of the top cover plate and baseplate assembly containing a plurality of filled containers; and

FIG. 22 is a perspective view of finished containers released from top cover plate.

### DETAILED DESCRIPTION

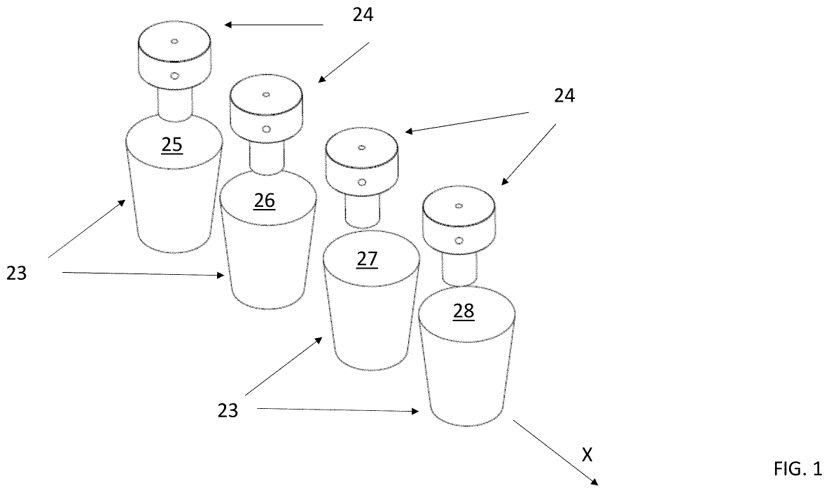

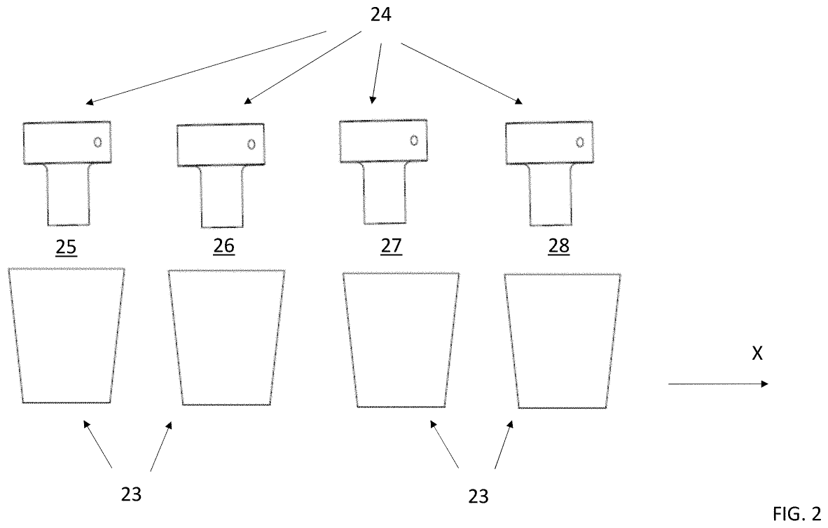

The figures illustrate a system that processes a uniquely designed conical/tapered metal container 23 and accompanying lid 30. The purpose of container 23 and lid 30 is to provide a vessel for a new type of mixed drink or craft cocktail beverage that can be consumed as a single serving or occasion. As shown in FIG. 1, the system comprises of a plurality of dispensing nozzles 24 located vertically (above) an opened container 23. FIG. 1 demonstrates a single lane system where a plurality of container 23 advances in direction X sequentially under nozzles 24. Each nozzle dispenses a discrete component or ingredient as prescribed in the beverage recipe where ingredient 25 is first inserted, the next nozzle dispensing ingredient 26, then 27 at the next and finally 28. Quantity of ingredient inserted ranges from 0.5 fluid ounces to 2 fluid ounces. The number of stations is not limited in this arrangement and is determined by the number of ingredients to be filled. The order of filling ingredients 25, 26, 27 and 28 is based on how a drink would be made by a skilled bartender or mixologist and in those specific orders. FIG. 2 identifies the approximate spacing and position of the nozzles 24 over the container 23 as they move in direction X.

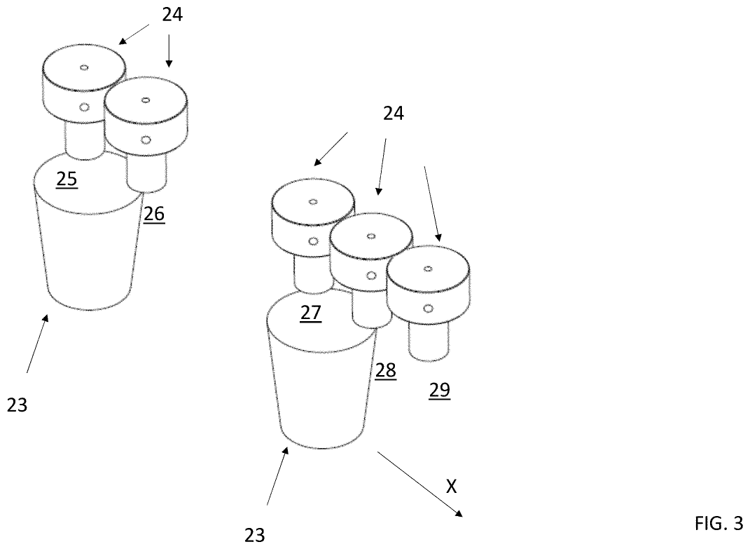

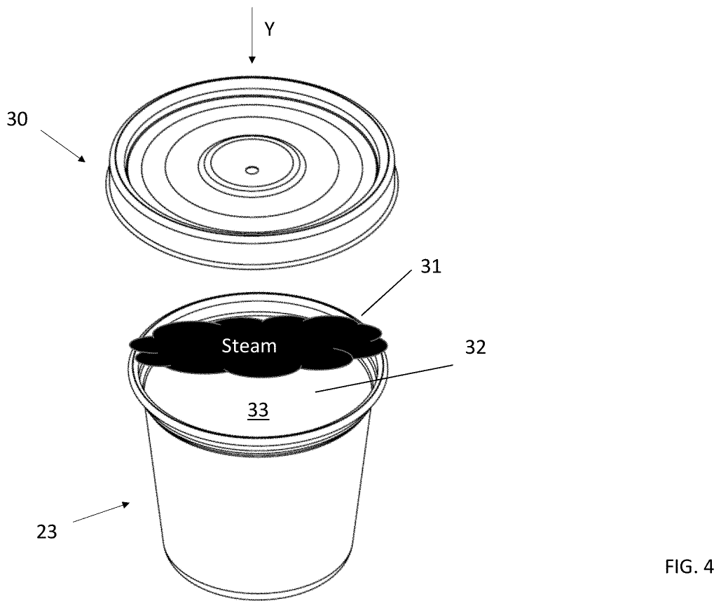

The system is also designed to accommodate a multiple lane as well as simultaneous filling of multiple ingredients in a single fill station. FIG. 3 identifies multiple nozzles 24 above container 23 at a single filling point where ingredients 25 and 26 are inserted simultaneously in one station and ingredients 27, 28 and 29 are in inserted in a subsequent station. The container 23 continues to move in direction X as part of the complete filling process. This option allows for a mimicking of a mixed drink whereby ingredients are poured together simultaneously by a skilled bartender or mixologist. The design is replicated in multiple lane options to increase throughput and capacity.

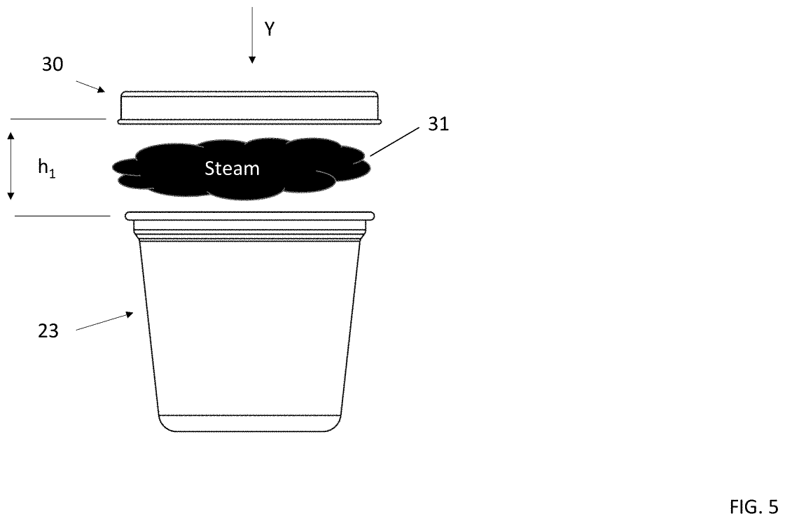

Once the filling process is complete the container 23 is further conveyed by cable, air deck or mechanical conveyor to a closing station. Container 23 now contains mixed drink 33 and has an unfilled volume 32; commonly referred to within the industry as “headspace”. Headspace 32 typically represents 5-10% of total container volume but no more than 10% of volume of container 23. In order to create a vacuum seal between container 23 and lid 30, saturated steam 34 is introduced into headspace 32, thereby, displacing ambient air present in 32. Saturated steam 31 has temperate in range between 210 degrees Fahrenheit to 350 degrees Fahrenheit. Once saturated steam 31 has been inserted into headspace 32, lid 30 is placed over container 23 in direction Y. FIG. 5 illustrates a side view of the saturated steam 31 insertion process with the gap between lid 30 and container 23 shown as h₁. Height h₁ is critical in maintaining optimal insertion and capture of saturated steam 31 into headspace 32 in order to create the designed vacuum seal. The height h₁ ranges in value between 0.125″ to 1.00″ with resulting vacuum inside closed container 23 and lid 30 to range between 250 mbar to 900 mbar.

FIG. 6 illustrates an alternative to using saturated steam 34 to create a vacuum seal in the finished container. Once the filling process depicted in FIG. 1-3 is complete, the container 23 now contains mixed drink 33 and is conveyed by cable, air deck or mechanical conveyor to a vacuum chamber 35. Vacuum chamber 35 is sealed with a vacuum pressurization 34 which has a range of value between 250 mbar to 900 mbar. The lid 30 is placed on container 23 in the direction Y while in the vacuum chamber resulting in vacuum 34 being maintained in the closed container once it exits vacuum chamber 35. Vacuum chamber 35 can accommodate a plurality of container 23 and lid 30 including the closing process.

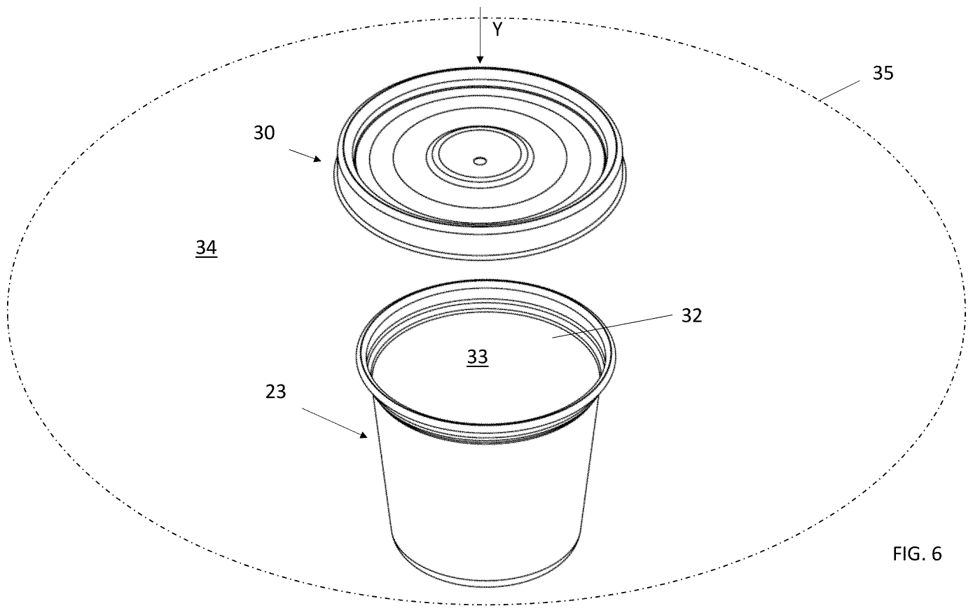

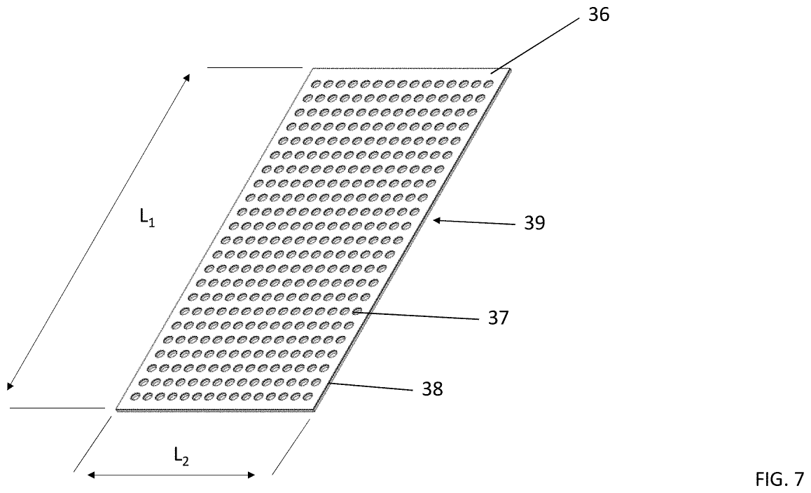

When using the saturated steam method for creating a vacuum seal, a force must be applied to the lid 30 in order to keep it in place as the steam cools, otherwise, the positive pressure relative to ambient will naturally displace the lid 30 from container 23. The system uses a unique top cover assembly 39 to hold the lid 30 in place while simultaneously providing a method to accelerate cooling and hence the creation of a vacuum seal. FIG. 7 illustrates the top cover assembly 39, which is comprises a multi-layer design of which the outer layer 36 is made of a durable substrate used in food and beverage processing systems such as stainless steel. A bottom layer 38 which is the contact later to lid 10, requiring it to be non-abrasive, and made from a material such as Delrin or Vinyl. Top cover assembly 39 has a length L₁ and width L₂ and a pattern of cooling channels 37 that are machine through 36 and 38. The length L₁ can range from 12.00″ to 48.00″ while width L₂ can have a value between 12.00″ and 24.00″.

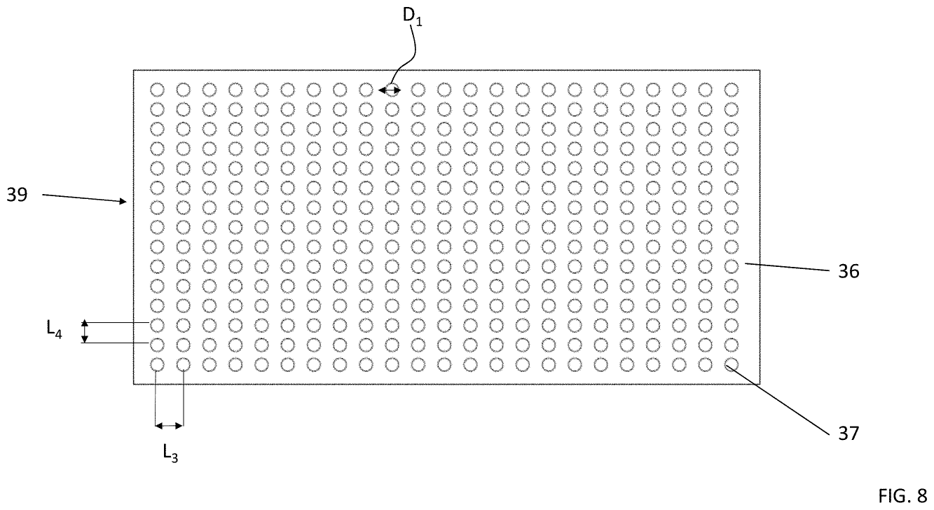

FIG. 8 shows a top view of top cover assembly 39 showing a pattern of cooling cavity 37 on outer layer 36. The diameter D₁ of the cooling cavity is defined by the cooling rate prescribed to allow the flow of cooling media through and onto lid 30 and sealed container 23. Diameter of cooling cavity D₁ has a range of value between 0.50″ to 1.50″. Additionally, another critical design aspect is the spacing of the cooling cavity D₁ in the lengthwise direction L₃ as well as in the widthwise direction L₄ as this spacing is responsible for the appropriate downward force required to keep the lid 30 in place on container 23 and maintain optimal flow of cooling media onto sealed containers. The value of spacing L₃ ranges between 1.25″ to 3.5″ whereas the value of spacing L₄ ranges between 1.25″ to 4.00″.

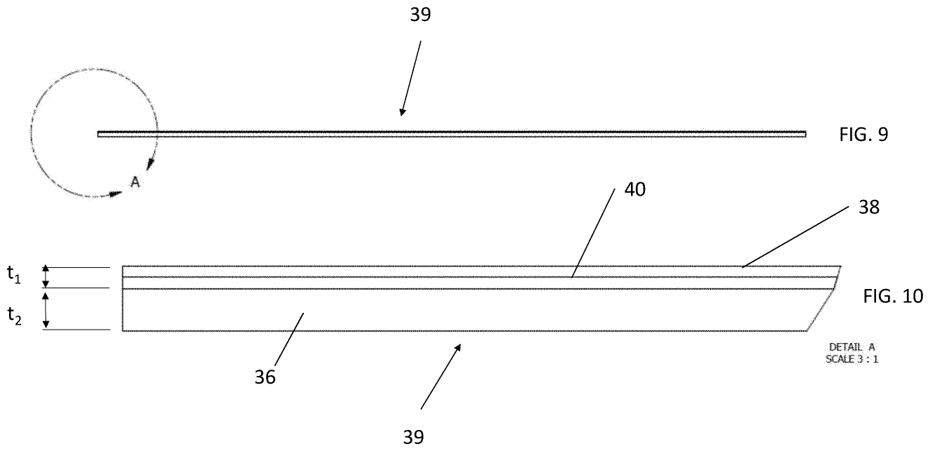

In FIG. 9, the top cover assembly 39 is shown in a side orientation with a detail of the assembly of layers shown in FIG. 10. Outer layer 36 is shown with a thickness t₂ and bottom layer 38 with a thickness t₁. In between layers 36 and 38 is a tie layer 40 which adheres bottom layer 38 to outer layer 36. Thickness t₁ has a range in value of 0.125″ to 0.300″ and thickness t₂ has a range in value between 0.125 to 0.500″.

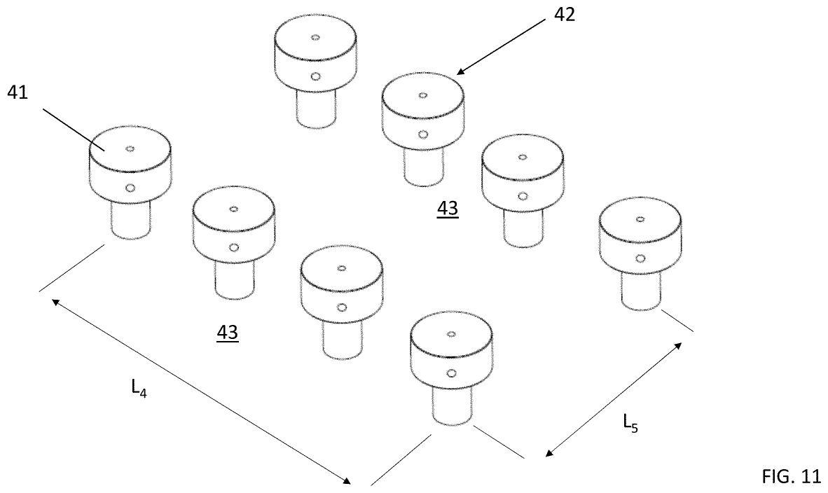

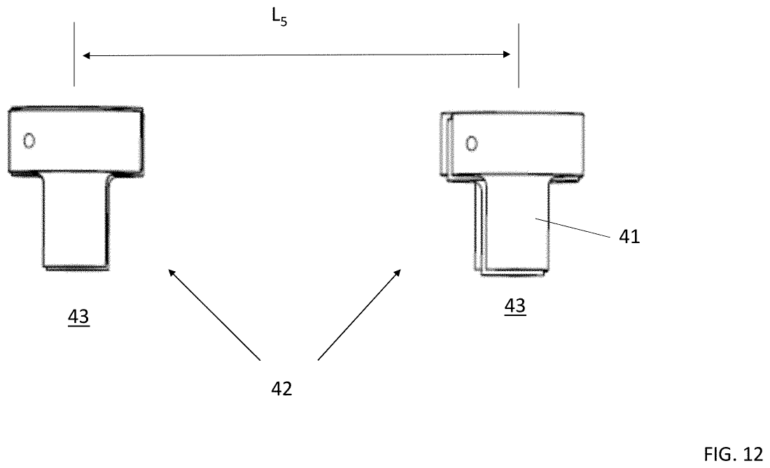

FIG. 11 and FIG. 12 illustrates a spray cooling system 42 comprised of a plurality of nozzles 41 that disperse a cooling media 43 on to the top cover assembly 39 during the cooling process. The spray cooling system 42 is arranged such that the length L₄ of the nozzles in the lengthwise direction corresponds to the length of the top cover 39 L₁ and the widthwise dimension L₅ corresponds to the width of the top cover assembly 39 L₂. The minimum flow rate for cooling media 43 is 1.25-1.5 gallons per minute with a pressurization level of a minimum of 60 pounds per square inches.

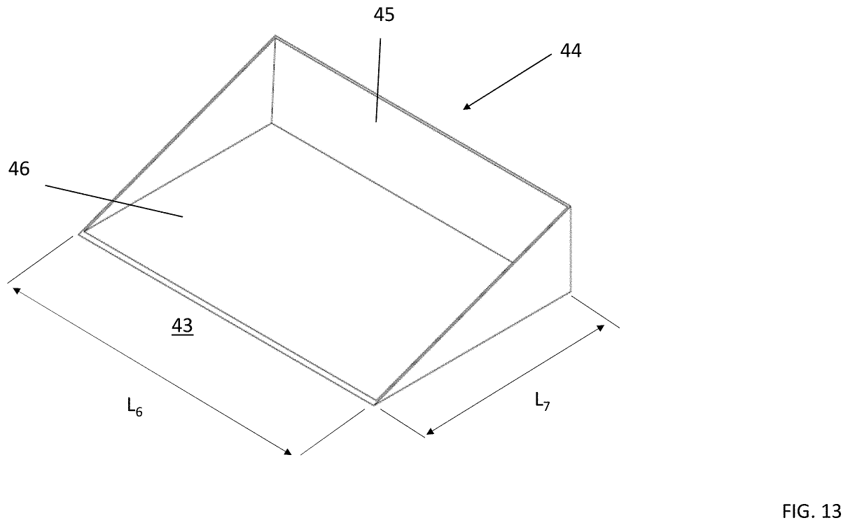

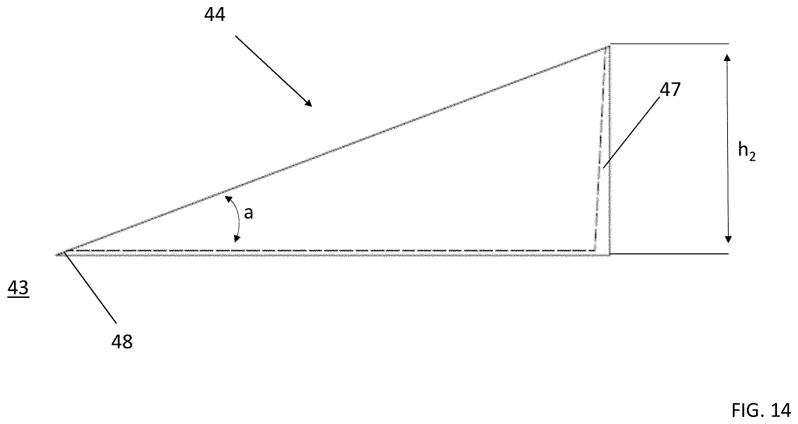

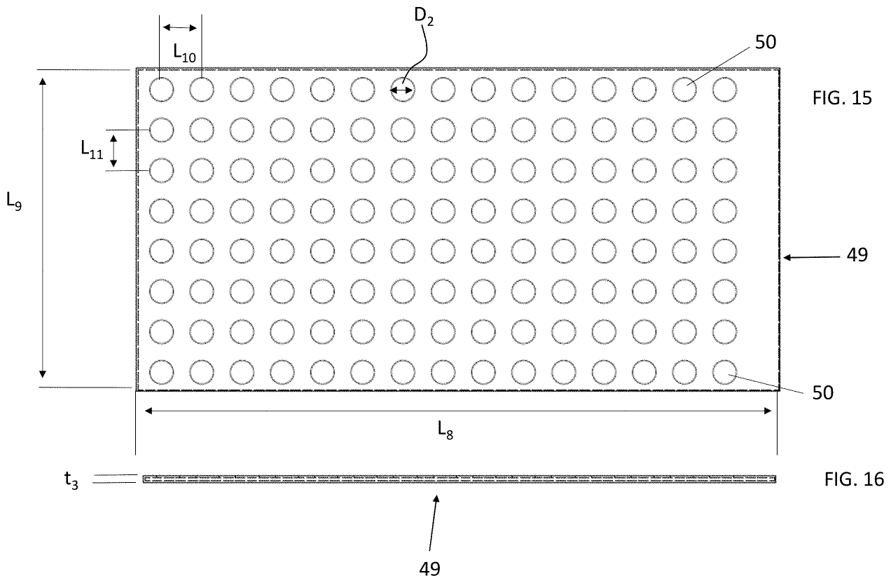

As an alternative to a spray cooling system 42, a waterfall cooling system 44 is illustrated in FIG. 13. The water cooling system 44 is made from durable material used in food and beverage processing, such as stainless steel, and comprised of a back and side plate 45 and base plate 46. The waterfall cooling system 44 has a width L₆ that corresponds to the width of the top cover assembly 39 L₂ and length L₇ that regulates the amount of cooling media 43 applied to the top cover assembly 39. FIG. 14 shows a side view of waterfall cooling system 44 with a side plate at an angle a and the height h₂ of back plate 45. The angle a has a range of 30 to 60 degrees where the height h₂ has range of 6.00″ to 12.00″. Waterfall cooling system 44 also incorporates angled features 47 and 48 that regulate the flow of the cooling media 43 such that the targeted flow rate is achieved. The minimum flow rate for cooling media 43 is 1.25-1.5 gallons per minute with a pressurization level of a minimum of 60 pounds per square inches.

To accommodate placement of container 23 into the cooling assembly, a matching baseplate 49 is used. Baseplate 49 is constructed from a single substrate that is durable and already used food and beverage processing, such as stainless steel. Baseplate 49 has a length L₈ that is identical to the length L₁ of the top cover assembly 39 as well as a width L₉ identical to the width dimension L₂ of the top cover assembly 39. A plurality of machined pockets 50 is incorporated into the interior face of the baseplate 49. The machine pocket 50 have a diameter D₂ that matches the diameter of the bottom of container 23 such that it provides a nesting effect. Diameter D₂ has a range of values between 1.50″ to 3.50″. Separation of machined pocket 50 to one another is defined by L₁₀ in the lengthwise direction and L₁₁ in the widthwise direction. The spacing of L₁₀ and L₁₁ is intended to prevent container 23 from interfering with one another as they are placed in machined pocket 50. As container 23 is conical in nature, the topmost diameter is larger than the bottom diameter and spacing needs to be considered. Values for L₁₀ and L₁₀ range from 3.00″ to 5.00″. FIG. 16 illustrates a side view of baseplate 49 showing a thickness t₃. The value of thickness t₃ ranges from 0.125″ to 1.00″.

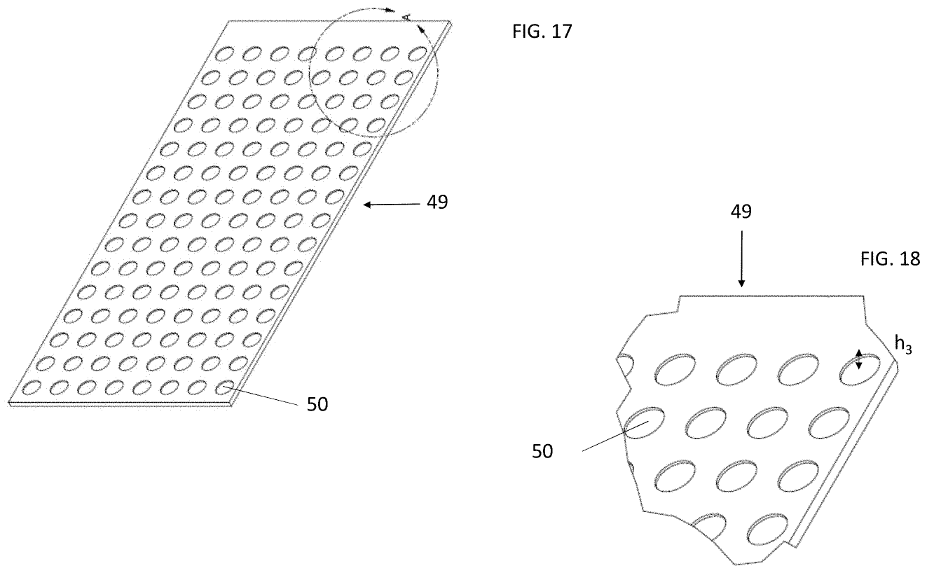

FIG. 17 shows an isometric view of baseplate 49 with a plurality of machined pocket 50. FIG. 18 illustrates in detail machine pocket 50 identifying the height of the feature defined as h₃. The height h₃ has a value of 0.100 to 0.250″.

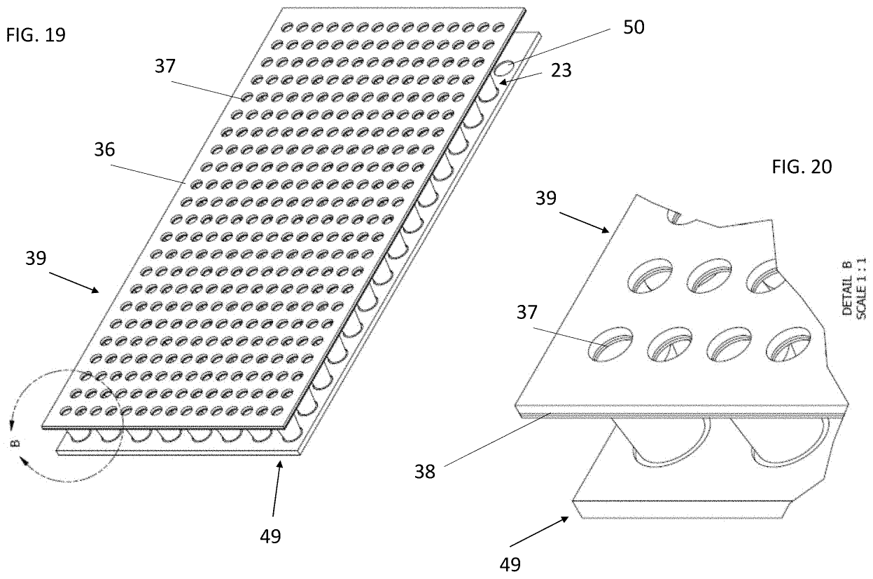

As the plurality of filled container 23 with lid 30 applied continues in the filling, closing and cooling process, these filled containers are placed on baseplate 49, specifically individually in machined pocket 50, until a plurality of containers is achieved. Top cover assembly 39 is placed on top of the plurality of containers to complete the cooling assembly as illustrated in FIG. 19. A detail of the cooling assembly is shown in FIG. 20.

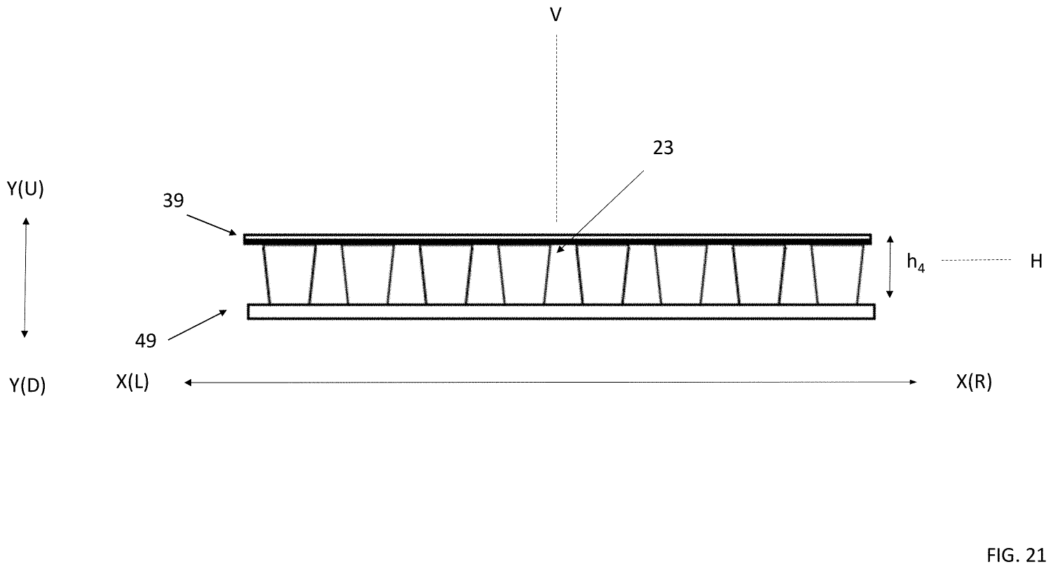

Once the filled and closed containers are cooled and/or vacuum seal is achieved, the system engages, clamping together to a height h₄. Height h₄ is based on the combined height of container 23 and thickness of lid 30 and ranges in value between 2.00″ to 8.00″. The cooling assembly activates to finish process mixed drink 33 by applying the appropriate agitating motion prescribed by the drink recipe. Similar to a real life scenario of a skilled bartender or mixologist either stirring or shaking the finished drink; the system allows for an identical set up motion as illustrated in FIG. 21. The cooling assembly represented by top cover assembly 39, baseplate 49 and a plurality of containers 23; filled and closed with lid 30, is moved in a horizontal motion about vertical axis V with amplitude and frequency defined by X(L) and X(R). Where amplitude; displacement about vertical axis V ranges in value between 1.00″ to 6.00″ and frequency ranges from 0.5 hertz to 5 hertz.

In addition, the cooling assembly is able to agitate in a vertical direction above horizontal plane H with amplitude and frequency defined by Y(U) and Y(D). Where amplitude; displacement about the horizontal axis H ranges in value between 1.00″ to 6.00″ and frequency ranges from 0.5 hertz to 5 hertz.

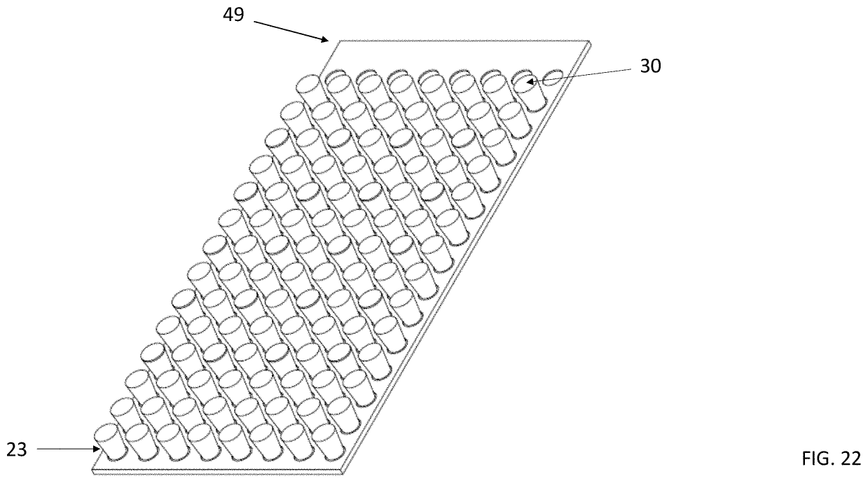

FIG. 22 illustrates a plurality of finished and sealed containers nested on baseplate 49 with top cover assembly 39 removed. The finished containers are available for conveyance by cable, air deck or mechanical conveyor to be finished packed.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

For purposes of this disclosure, the term “assembly” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

Containers discussed herein may include containers of any style, shape, size, etc. For example, the containers discussed herein may be shaped such that cross-sections taken perpendicular to the longitudinal axis of the container are generally circular. However, in other embodiments the sidewall of the containers discussed herein may be shaped in a variety of ways (e.g., having other non-polygonal cross-sections, as a rectangular prism, a polygonal prism, any number of irregular shapes, etc.) as may be desirable for different applications or aesthetic reasons. In one embodiment, container 23 may be hourglass shaped. Container 23 may be of various sizes as desired for a particular application.

Further, container 23 could be used in combination with alternative lid designs (e.g., a screw closure, cap, cover, top, end, can end, sanitary end, “pop-top”, “pull top”, convenience end, convenience lid, pull-off end, easy open end, etc.). The container end may be any element that allows the container to be sealed such that the container is capable of maintaining a hermetic seal.

The containers discussed herein may be used to hold beverage products (e.g., juice, mixers, sports drinks, alcohol, liquor or combinations thereof). It should be understood that the phrase “beverage” used to describe various embodiments of this disclosure may refer to a liquid, or any other drinkable or edible material in viscous form.

What is claimed is:

1. A system for filling, closing and finish processing of craft beverage comprising:
a system of nozzles that simulate the filling of ingredients in order and real world conditions;
a method of closing a unique container design resulting in a vacuum seal;
a top cover plate that maintains appropriate force to prevent the lid to the container from dislodging during process;
a cooling system that delivers cooling media over the top cover plate and onto the filled containers
a baseplate that accommodates the unique container design which prevents slippage during processing
a system that agitates the finished containers to simulate real world mixing of ingredients in a craft beverage

2. The system of claim 1 wherein the ingredients are filled separately under one station.

3. The system of claim 1 wherein the number of lanes, input of containers, vary from 1 to 10.

4. The system of claim 1 wherein the method where saturated steam is introduced into a headspace, representing 5-10% of the container volume, at a temperature between 210 degrees Fahrenheit to 350 degrees Fahrenheit,

5. The system of claim 1 wherein a spray system is used to introduce a cooling media to reduce the temperature of the contents of the sealed container to between 70 degrees Fahrenheit to 80 degrees Fahrenheit,

6. The system of claim 1 wherein the sealed and cooled containers is agitated about a vertical axis, simulating a stir motion,

7. The system of claim 1 wherein the ingredients are filled simultaneously under one station,

8. The system of claim 1 wherein the final vacuum achieved on the sealed container is between 250 mbar to 900 mbar,

9. The system of claim 1 wherein a waterfall cooling system is used to introduce a cooling media to reduce the temperature of the contents of the sealed container to between 70 degrees Fahrenheit to 80 degrees Fahrenheit,

10. The system of claim 1 wherein the sealed and cooled containers is agitated about a horizontal axis, simulating a shake motion,

11. The system of claim 1 wherein the top cover assembly is made up of assembled layers of stainless steel, a tie layer and a durable layer that does not scratch the container; such as Delrin or Vinyl,

12. The system of claim 1 wherein the top cover assembly has machined features that allow cooling media to flow through at a minimum prescribed rate of 1.25-1.5 gallons per minute with a pressurization level of a minimum of 60 pounds per square inches,

13. The system of claim 1 wherein the agitation displacement and frequency about the vertical or horizontal axis is 1.00″ to 6.00″ and frequency ranges from 0.5 hertz to 5 hertz,

14. The system of claim 1, wherein the fill volume of the containers processed is between 3 fluid ounces to 12 fluid ounces,

15. A system for filling, closing and finish processing of craft beverage comprising:
a system of nozzles that simulate the filling of ingredients in order and real world conditions comprising;
a method of closing a unique container design while in a vacuum chamber resulting in a vacuum seal,
a system that agitates the finished containers to simulate real world mixing of ingredients in a craft beverage

16. The system of claim 15 wherein the ingredients are filled separately under one station.

17. The system of claim 15 wherein the number of lanes, input of containers, vary from 1 to 10.

18. The system of claim 15 wherein the vacuum chamber has a vacuum value between 250 mbar to 900 mbar,

19. The system of claim 15 wherein a lid is placed on the container using a mechanical or pneumatic device without breaking the system vacuum seal

20. The system of claim 15 agitated about a horizontal axis, simulating a shake motion,

21. The system of claim 15 the vacuum contained in the sealed container represents a volume of 5-10% of the container volume,

22. The system of claim 15 wherein the sealed and cooled containers is agitated about a vertical axis, simulating a stir motion,

23. The system of claim 15 wherein the ingredients are filled simultaneously under one station,

24. The system of claim 15 wherein the agitation displacement and frequency about the vertical or horizontal axis is 1.00″ to 6.00″ and frequency ranges from 0.5 hertz to 5 hertz,

25. The system of claim 15, wherein the fill volume of the containers processed is between 3 fluid ounces to 12 fluid ounces,
